(19) United States
(12) Patent Application Publication
(10) Pub. No.: US 2026/0152114 A1
(43) Pub. Date: Jun. 4, 2026

(54) MOUNTABLE / DEMOUNTABLE / REMOUNTABLE INTERCHANGABLE EQUIPMENT SLED

(71) Applicant: HURST ENGINEERED ADVANCED TECHNOLOGIES (HEAT) LLC, Reno, NV (US)

(72) Inventors: Stephen Lowell HURST, Reno, NV (US); Robert Ian HURST, Rescue, CA (US)

(73) Assignee: HURST ENGINEERED ADVANCED TECHNOLOGIES (HEAT) LLC, Reno, NV (US)

(21) Appl. No.: 19/107,413

(22) PCT Filed: Aug. 29, 2024
(86) PCT No.: PCT/US2024/044328

§ 371 Date: Feb. 27, 2025

Related U.S. Application Data
(60) Provisional application No. 63/579,867, filed on Aug. 31, 2023.

(51) Int. Cl. B60P 1/64; A62C 25/00; A62C 27/00

(52) U.S. Cl. CPC B60P 1/64; A62C 25/00; A62C 27/00

(57) ABSTRACT

An interchangeable equipment sled that includes a frame holding equipment operatively attached thereto and is easily and rapidly mountable or demountable on a vehicle. A method of adding or removing the interchangeable equipment sled to or from a vehicle, by operating a lift mechanism to lift the interchangeable equipment sled without the use of a crane, forklift, or other heavy machinery, placing the interchangeable equipment sled on the vehicle, and optionally locking the interchangeable equipment sled in place. A method of using the interchangeable equipment sled, by driving a vehicle including the interchangeable equipment sled, and using the equipment. A method of using the interchangeable equipment sled to fight a fire, by driving a vehicle including the interchangeable equipment sled with fire equipment to a fire scene, and using the fire equipment to fight the fire.

### BACKGROUND OF THE INVENTION

### 1. Technical Field

The present invention relates to apparatus and equipment for improving the utility of pickup and flatbed light to medium duty trucks.

### 2. Background Art

Light to medium duty trucks (less than 40,000 lbs. GVWR) are ubiquitous in the United States with significant numbers worldwide. Unit sales in the US are expected to exceed 3,000,000 in 2023 with an average cost in excess of $30,000 and an annual global market exceeding $200 billion. Such vehicles comprise a passenger compartment or cab seating 2 to 6 or more passengers and a utility platform, often in the form of a walled bed and tailgate or flatbed, either of which can be fitted with a utility skid bolted to the frame or bed. Utility skids come in various forms from water or fuel tanks, welding/generator equipment, etc., and, of particular interest herein, firefighting apparatus.

Fire departments in particular (both volunteer and fulltime) usually have multiple types of vehicles for different types of equipment. Some of the equipment, including pickup trucks, are dedicated for specialty purposes so any truck carrying that equipment is not used a majority of the time in most departments. This results in many vehicles that are just sitting around not in use, and taking up space in the firehouse. It would be advantageous to have interchangeable equipment units to reduce the number of trucks needed.

Also, the electrification of transportation is rapidly gaining momentum worldwide, including electric pickup trucks. It would be advantageous to have a utility skid comprising an auxiliary battery for extended range or mobile charging of other electric vehicles.

U.S. Pat. No. 3,770,060 to Forsyth, et al. discloses a firefighting unit that can be installed on a cargo truck 1. Equipment such as tanks 3, pump 4, and hose reels 5 are mounted on a frame that can be loaded onto the truck bed 11 and attached thereto. When not in use, the modular unit can be stored on a stand. The modular unit can also be placed at remote sites for use. Forsyth, et al. however does not disclose a modular system that include other types of equipment on different skids.

U.S. Pat. No. 4,842,326 to DiVito discloses modular motor vehicles that have a plurality of interchangeable chassis modules that are easily connected and disconnected from the core vehicle. For example, a dumping module 122 can be added to the core vehicle.

U.S. Pat. No. 10,850,659 to Stocks, et al. discloses a system 100 for an interchangeable truck bed unit 110 that detachably couples with a truck chassis. The bed unit 110 can be a dump truck bed, a heavy equipment bed, a bed for hauling minerals or mining equipment, a military gun turret bed, a military personnel transport bed, a military HUMVEE bed, a specialized bed (e.g., a glass carrier bed, a utility bed, a landscaping equipment bed), or a limousine bed.

While interchangeable units of equipment for vehicles exist, they are not easy to mount and/or replace and require the use of a forklift or crane, as well as removal of bolts that fix the unit to the vehicle. There remains a need for easily mountable, demountable and remountable equipment units for pickup trucks and other vehicles.

### SUMMARY OF THE INVENTION

The present invention provides for an interchangeable equipment sled that includes a frame holding equipment operatively attached thereto and is easily and rapidly mountable or demountable on a vehicle.

The present invention provides for a method of adding or removing the interchangeable equipment sled to or from a vehicle, by operating a lift mechanism to lift the interchangeable equipment sled without the use of a crane, forklift, or other heavy machinery, placing the interchangeable equipment sled on the vehicle, and optionally locking the interchangeable equipment sled in place.

The present invention provides for a method of removing the interchangeable equipment sled from a vehicle by optionally unlocking the interchangeable equipment sled from the vehicle, operating the lift mechanism to lift the interchangeable equipment sled from the vehicle, and moving the vehicle away.

The present invention provides generally for a method using the interchangeable equipment sled, by driving a vehicle including the interchangeable equipment sled, and using the equipment.

The present invention also provides for a method of using the interchangeable equipment sled to fight a fire, by driving a vehicle including the interchangeable equipment sled with fire equipment to a fire scene, and using the fire equipment to fight the fire.

The present invention provides for a method of using the interchangeable equipment sled to charge a vehicle's battery, by driving a vehicle including the interchangeable equipment sled with battery equipment, wherein the battery equipment is operatively connected to the vehicle, and charging the vehicle with the battery equipment.

The present invention provides for a method of using the interchangeable equipment sled to add fuel to a vehicle's fuel tank, by driving a vehicle including the interchangeable equipment sled with fueling equipment, wherein the fueling equipment is operatively connected to a fuel tank of the vehicle, and adding fuel to the vehicle with the fueling equipment.

### DESCRIPTION OF THE DRAWINGS

Other advantages of the present invention are readily appreciated as the same becomes better understood by reference to the following detailed description when considered in connection with the accompanying drawings wherein:

FIG. 1 is rear left quarter panel perspective view of a vehicle with an interchangeable equipment sled;

FIG. 2 is a rear right quarter panel perspective view of a vehicle with an interchangeable equipment sled;

FIG. 3 is a rear left side perspective view of a frame of the interchangeable equipment sled with equipment;

FIG. 4 is a back view of a frame of the interchangeable equipment sled with equipment;

FIG. 5 is front view of a control panel;

FIG. 6 is a side view of piping;

FIG. 7 is a front view of a control panel;

FIG. 8 is a right rear side perspective view of a control panel;

FIG. 9 is a rear view of a vehicle with an interchangeable equipment sled;

FIG. 10 is a view of an illuminated control panel;

FIG. 11 is a side perspective view of a water tank with baffles and top mounted equipment storage racks;

FIG. 12 is a left rear side perspective view of the interchangeable equipment sled lifted with a fork lift;

FIG. 13 is a view of a jack stand used to lift the interchangeable equipment sled;

FIG. 14 is a view of a jack stand used to lift the interchangeable equipment sled on or off of a vehicle; and

FIG. 15A is a top perspective view of an attachment mechanism in a truck bed, FIG. 15B is a side view of a gooseneck puck, and FIG. 15C is a side perspective view of the interchangeable equipment sled attached within a truck bed.

### DETAILED DESCRIPTION OF THE INVENTION

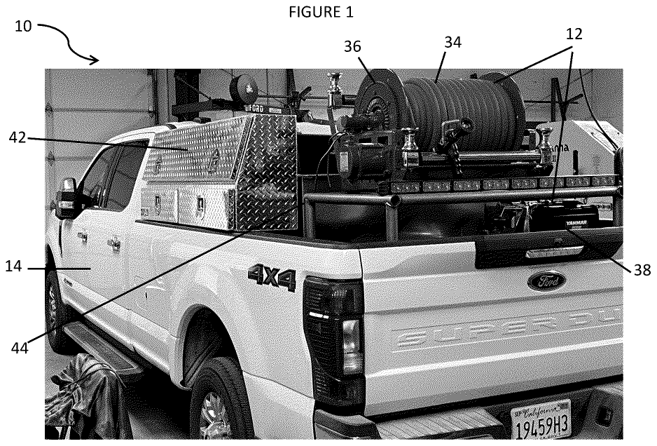

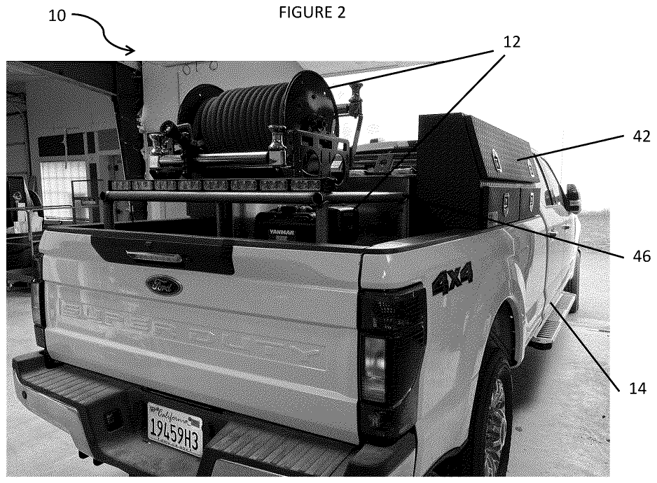

The present invention is generally directed to an interchangeable equipment sled 10 that includes a frame 16 holding equipment 12 and is easily and rapidly mountable on or demountable from a vehicle 14, shown generally in FIG. 1 and FIG. 2. The interchangeable equipment sled 10 allows for an individual to have one vehicle 14 that can be used for multiple purposes. While the interchangeable equipment sled 10 is shown in the FIGURES for the purposes of firefighting, it should be understood that the interchangeable equipment sled 10 can be designed for other uses further described below.

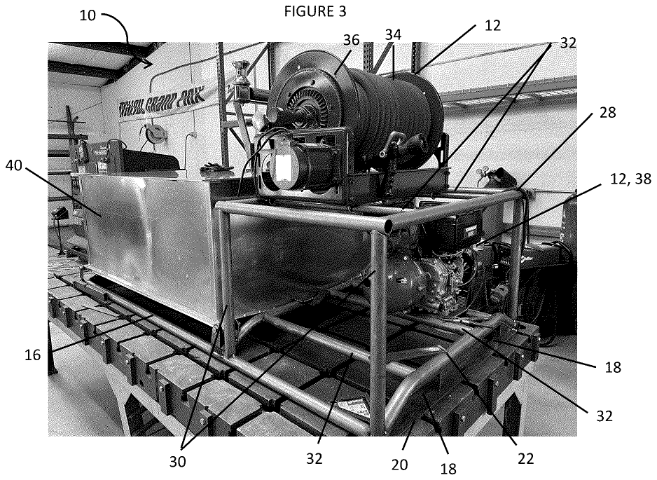

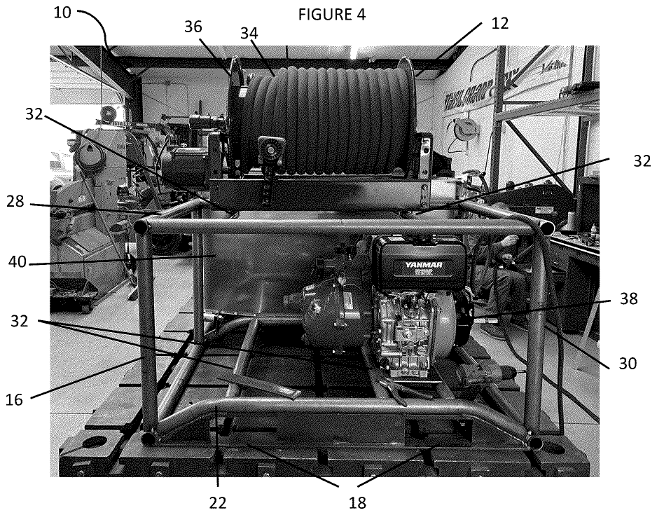

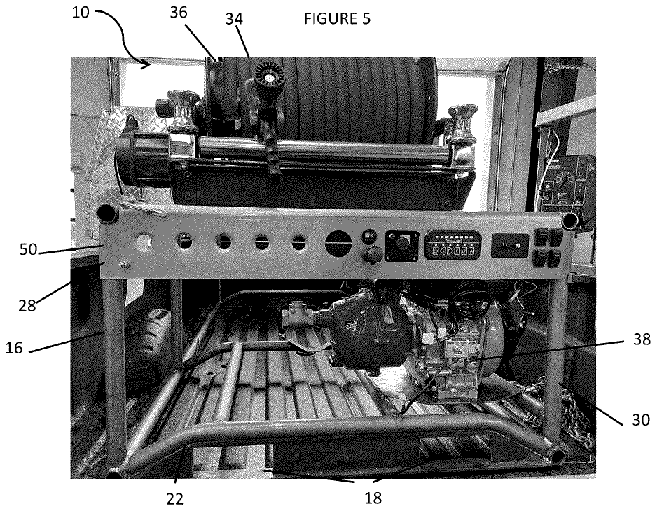

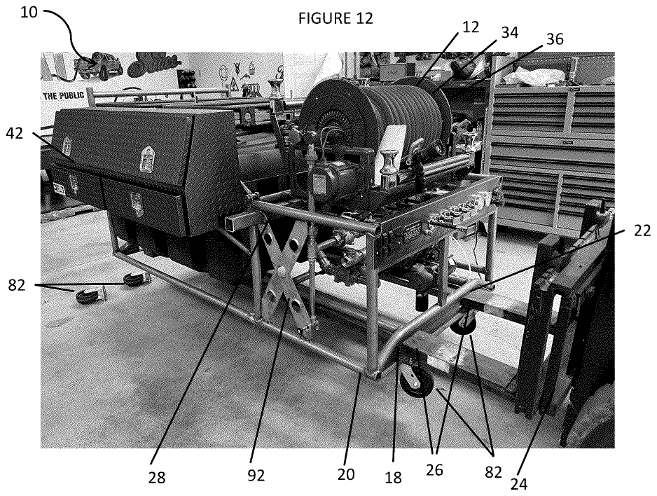

The interchangeable equipment sled 10 includes a frame 16 made of a lightweight and strong material, generally shown in shown in FIGS. 3-4, such as 120 wall 1.75 inch tube steel. The frame 16 can be solid or preferably hollow to reduce weight of the interchangeable equipment sled. The interchangeable equipment sled 10 can be made within the weight requirements of various trucks and cars, as well as still allow for space within the vehicle 14, such as within a truck bed 15 or trunk space if needed. The frame 16 includes a base portion 20 and a raised portion 22 operatively attached to the base portion 20. The frame 16 is strong enough to be lifted with a forklift 24 (shown in FIG. 12), and can receive forks 26 of the forklift 24 through a slot 18 between the base portion 20 and the raised portion 22. The raised portion 22 protects any equipment 12 on the frame 16 from contact with the forklift 24. The raised portion 22 can include a plurality of crossbars 32 to support equipment 12. The raised portion 22 can run an entire length of the frame 16 or a part of the frame 16. The frame 16 can also include a top portion 28 for receiving equipment 12 that is operatively attached through a plurality of vertical portions 30 to the base portion 20. The top portion 22 can run an entire length of the frame 16 or a part of the frame 16. The top portion 22 can also include a plurality of crossbars 32 to support equipment 12. The frame 16 can include additional support structures 92 (such as crossbars) where needed such as shown in FIG. 12. The frame 16 can be sized to fill a vehicle bed 15 for stability or be sized less than a bed so that there is room for loading additional things on the vehicle 14. The frame 16 can generally be rectangular or square in shape.

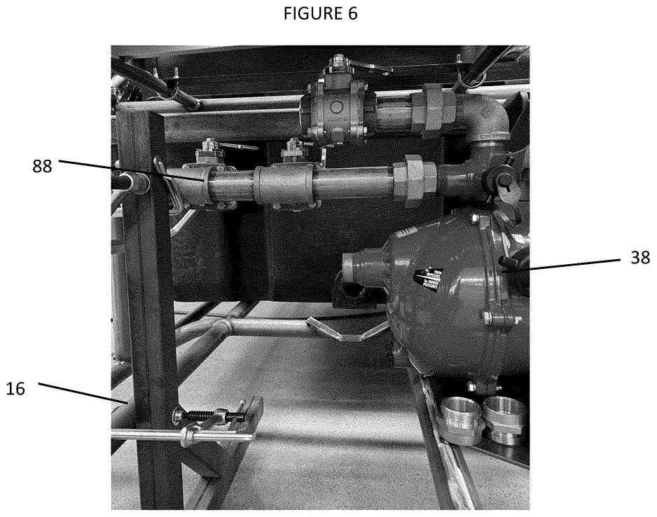

The equipment 12 can be fire equipment (hoses, water tanks, foaming devices which can provide up to 2400 gallons of fire suppression capability or more), batteries (to provide battery power at a remote site or to provide additional battery power/extended range to a vehicle 12), fuel tanks (to provide extended range of fuel to a vehicle 14), pesticide tanks for applying pesticides, dumpster equipment, welding equipment, salt or sand equipment for snow plows or sanding uses, or any other type of equipment or combinations of equipment. Custom combinations of equipment types can be included, and equipment 12 can be located in any desired part of the frame 16. For example, in the FIGURES, a hose 34 and hose reel 36 are provided on the top portion 28 of the frame 16 and a pump 38 is provided on the raised portion 22 that is operably connected to a water tank 40 and the hose 34. The pump 38 can be in fluid connection with the hose 34 and/or water tank 40 with easy to assemble and disassemble conduits 88 shown in FIG. 6.

The hose 34 can be a 1″ Forestry Discharge Booster Fire Hose Reel-Lite 100′ NPSH (NFPA Rated) RED and Nozzle that includes single jacket construction with abrasion resistant cover, rigid helical reinforcement with ethylene propylene diene monomer (EPDM) rubber lining, field replaceable fittings, is lightweight and kink resistant, and rated 400/800/1200 Service/Proof/Burst. A set of hoses 34 can be included such as 1×2.52 50′ forestry hose, 3×1.52 100′ forestry hose, and 3×12 100′ forestry hose. A foam cartridge nozzle system can be included for full foam capability without a foam tank.

The hose reel 36 can be a HANNEY® F32-19-21 steel hose reel. This includes a gear-driven crank rewind, electric powered chain and sprocket drive, pinion brake, standard inlet of 1″ 90° ball bearing swivel joint with 1″ female NPT threads, standard outlet of 1″ male NST threads (1.375″×8 threads per inch), standard inlet, outlet riser, and hub assembly made of steel, front and rear rollers, standard pressures to 1000 psi (69 bar), and standard fluid temperatures from −40° F. to +250° F. (−40° C. to +121° C.).

A side mounted 1.5″ MNHT discharge and top mounted 2.52 FNHT 90° elbow inlet for drafting or hydrant connection can be included.

A plurality of top mounted hose or equipment racks and side mounted, single box over two drawer utility compartments can be included.

The pump 38 can be a two stage fire pump with 10 hp YANMAR® diesel electric start engine. Alternatively, a Honda gasoline engine can be used. The diesel engine has low oil protection and a spark arrestor/exhaust diverter. The performance can be 120 gpm (454 L/M) at @ 36 psi (2.5 bar), 95 gpm (378 L/M) at 83 psi (5.7 bar), 60 gpm (227 L/M) at 118 psi (8.1 bar), or 20 gpm (76 L/M) at 144 psi (9.9 bar). It features marine-grade aluminum casing, 3-way discharge port with one 11/22 NPTM or two 1″ NPTM, 11/2″ NPTM suction, zinc-plated casing bolts, mechanical shaft seal, nitrile rubber seal and casing “o” rings, and self-priming up to 19′. A HALE® fluidless priming pump assures drafting performance.

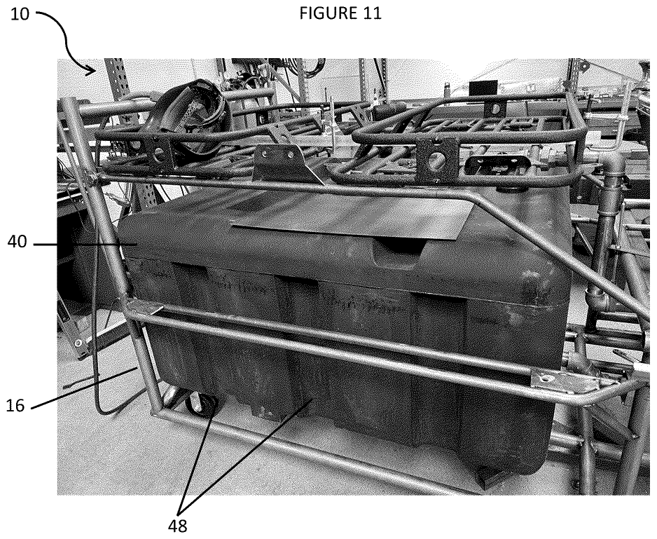

The water tank 40 can also be provided on the raised portion 22. The water tank 40 can be made of molded plastic or metal and optionally include a plurality of baffles 48 (shown in FIG. 11) to prevent unwanted movement of water in the water tank 40. The baffles 48 can be located in alternating locations on each side of the water tank 40. The water tank 40 can be any suitable size, such as, but not limited to, 300 gallon, 200 gallon, or 150 gallon. At least one utility box 42 can be included on the frame 16 in any suitable location such as on a first side 44 or second side 46. The equipment 12 can be operatively attached and mounted on the interchangeable equipment sled 10 by any appropriate mechanism and can be easy to remove.

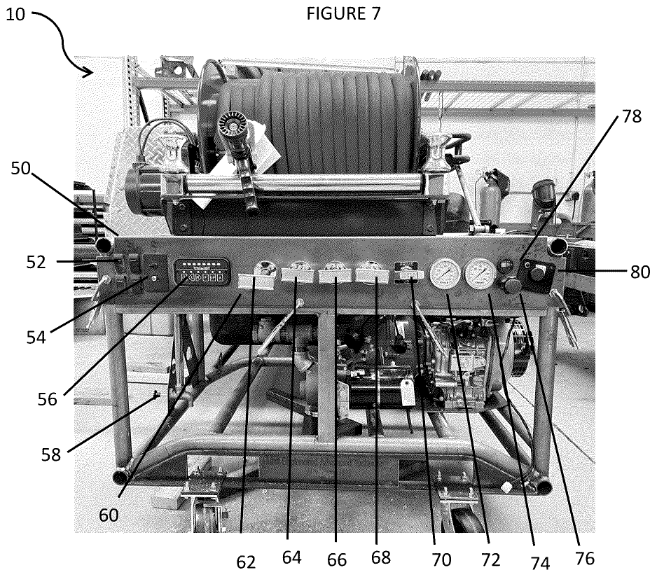

A control panel 50 (shown in FIGS. 5 and 7-9) can be operatively attached to the frame 16 in any suitable location but preferably along the top portion 28. The control panel 50 can be made of the same materials as the frame 16 or any other suitable material. Arranged on the control panel 50 can be controls for the equipment 12 as well as other functions as desired. For example, for firefighting uses, the control panel 50 can include at least one light switch 52, a remote spot light 54 (that can be 320 degrees rear facing), a traffic director control 56 (such as by WHELEN®), a hose reel switch 60, a hose reel valve 62, a discharge valve 64 (such as 1.5 inch), a tank fill/recirculate valve 66, a tank to pump valve 68, a primer switch/valve 70 an inlet pressure gauge 72 (such as 2.5″ HALE® pressure gauge), a discharge pressure gauge 74 (such as 2.5″ HALE® pressure gauge), a pump throttle 76, a tank level gauge 78, and a pump electric start 80. A drain valve 58 is also included operably attached to the water tank 40. Any valve handles can be panel mounted push/pull valve handles with 1.5″ AKRON BRASS® stainless steel ball valves. A side swing handle 2.5″ AKRON BRASS® stainless steel ball inlet valve can be used.

Electronic equipment can be included as follows. A self-contained 12 VDC marine grade electrical system can include a 12 VDC deep cycle batter, AC/DC shoreline charger, DC/DC charger connected through a 7 blade trailer pig tail, solar trickle charger for extended off bed use, and a pump alternator that charges the battery while pumping. LED lighting can be used in the control panel 50, pump house, and any compartments. A GPS tracking device can be included on any interchangeable equipment sled 10 to allow a user to locate and retrieve field deployed equipment remotely.

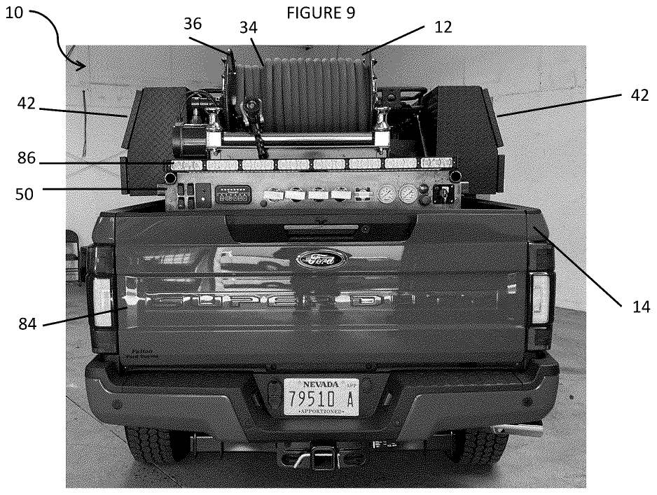

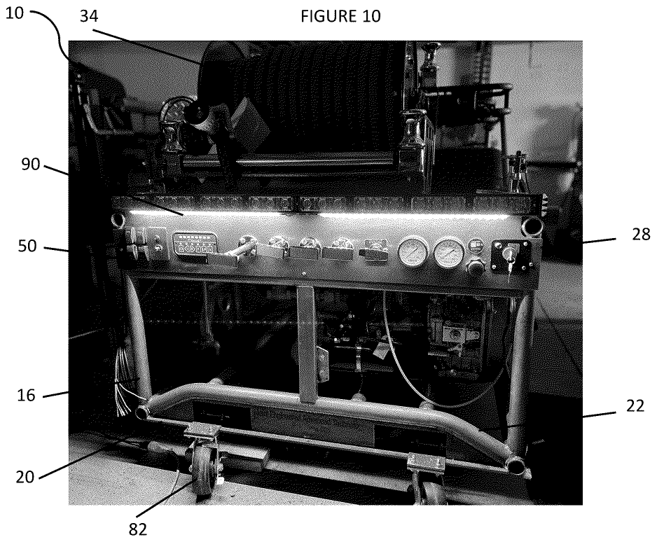

As shown in FIG. 9, the control panel 50 is easily accessible when the interchangeable equipment sled 10 is within a truck bed 15 when a tailgate 84 is up and the control panel 50 rests above the tailgate 84. In prior art equipment sleds, the tailgate is required to be removed in the vehicle to insert the sled and the sled must be fixed within the vehicle. In the present invention, the tailgate 84 can stay intact and the interchangeable equipment sled 10 can be removed easily from the vehicle 14. There are many essential systems within the tailgate 84 and if it is removed, functionality of the vehicle 14 is removed. Once the interchangeable equipment sled 10 is removed from the vehicle 14, the vehicle 14 can function as normal including the tailgate 84. A traffic director 86 can be operatively attached on top of the control panel 50 for controlling traffic around the vehicle 14. The control panel 50 can be illuminated with lights 90 as shown in FIG. 10 and the lights can be integrated in any suitable place along the control panel 50. The control panel 50 can be connected to a vehicle power source through a trailer coupling (pigtail) or it can run on battery power.

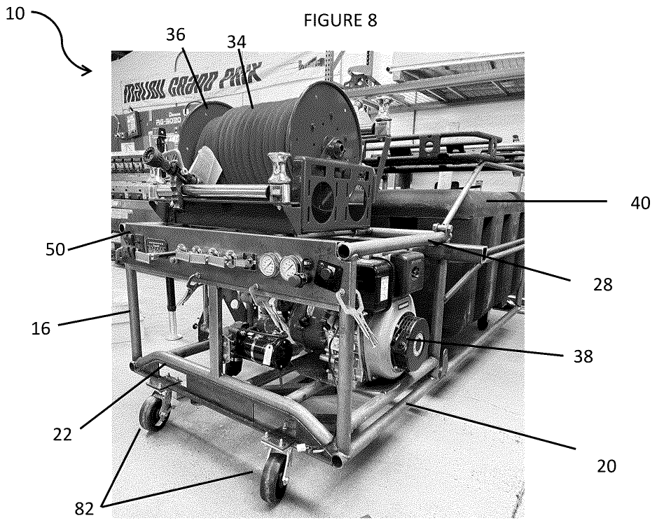

The frame 16 can further include a plurality of wheels 82 removably attached along the base portion 20, shown in FIGS. 8, 10, and 12. The wheels allow the interchangeable equipment sled 10 to be easily pushed and moved by an individual or group of individuals when on a level surface such as in a garage or road. Alternatively the interchangeable equipment sled 10 can be placed on a wheeled cart for movement. A tractor can also easily move the interchangeable equipment sled 10 if outdoors on land, such as if it is dropped off at a farm.

The equipment 12 can be operated or turned on/off manually or with an application on a smartphone with BLUETOOTH® or wireless communication.

The vehicle 14 can be a car, pickup truck, flat bed truck, semi truck, trailer, or any other vehicle. The interchangeable equipment sled 10 can be sized to fit on any existing vehicle 14 or be manufactured to be included on new vehicles 14. Multiple vehicles 14 can be used, such as a pickup truck and a trailer, to carry multiple interchangeable equipment sleds 10.

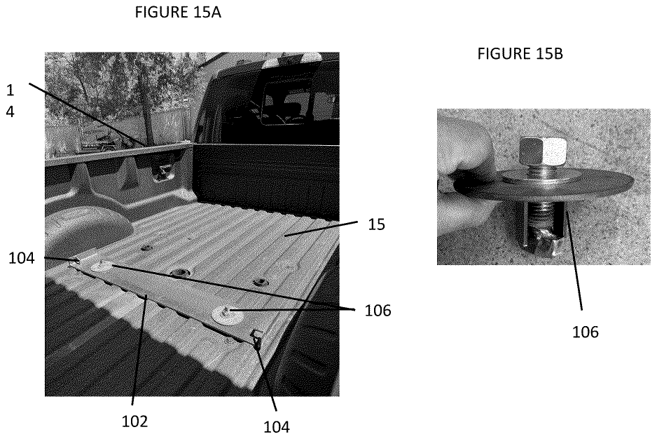

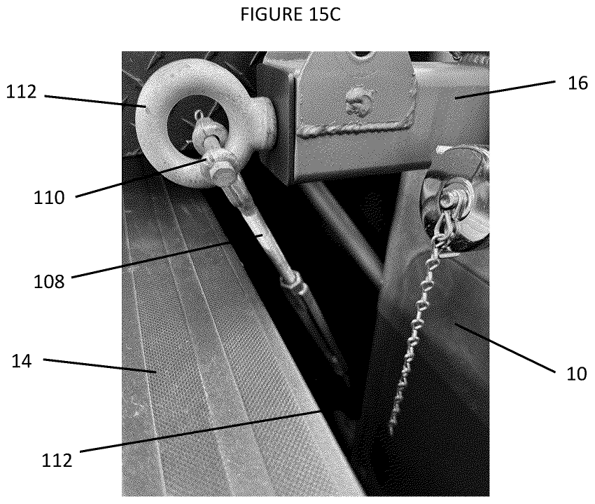

The interchangeable equipment sled 10 can further include any suitable locking/attachment mechanism to lock the interchangeable equipment sled 10 in place on the vehicle 14. However, a locking mechanism is not necessary as the interchangeable equipment sled 10 can be heavy enough to stay in place within the vehicle 14. The interchangeable equipment sled 10 can further include any suitable locking or attachment mechanism 100 to lock the interchangeable equipment sled 10 in place on the vehicle 14. However, a locking or attachment mechanism 100 is not necessary as the interchangeable equipment sled 10 can be heavy enough to stay in place within the vehicle 14. FIGS. 15A-15C show an example of a locking or attachment mechanism 100 that includes a tie down plate 102 having a plurality of tie down points 104 (preferably two at opposite sides of the vehicle 14). The tie down plate 102 mounts to a gooseneck puck system 106 of a truck bed 15. The tie down plate 102 can have 90 degree bends on either side preventing any side to side motion of the interchangeable equipment sled 10. FIG. 15C shows the interchangeable equipment sled 10 within the vehicle 14, and the frame 16 can be secured to the locking or attachment mechanism 100 through at least one rod 108 that is removably attached at a first end 110 to an attachment point 112 of the frame 16 and removably attached at a second end 114 to the tie down point 104. The attachment point 112 can be any suitable place on the frame 16 that lines up with the gooseneck puck system 106. The attachment point 112 can slide into a 2″ receiver tube 116 on the frame 16.

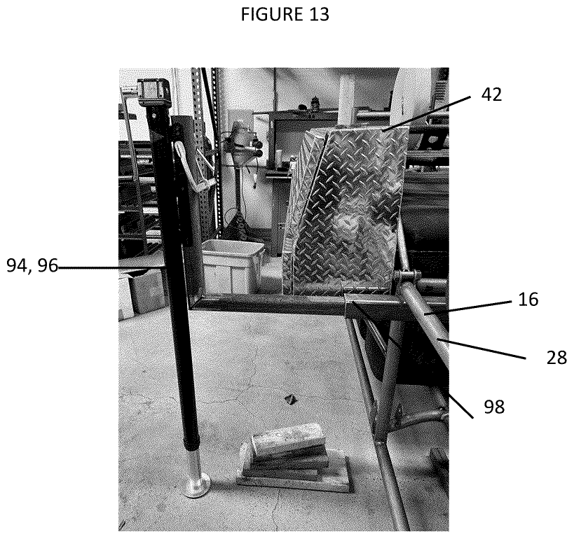

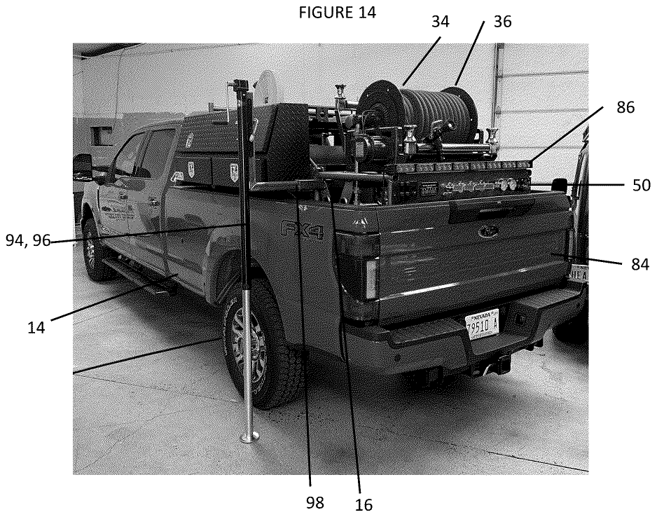

The interchangeable equipment sled 10 can easily be added or removed from a vehicle 14 without a crane or forklift with a lift mechanism 94, shown in FIGS. 13-14. One example of a lift mechanism 94 is at least one camper jack 96 that can be placed within a jack receiving slot 98 operatively integrated in the frame 16 to lift the interchangeable equipment sled 10 off of the vehicle 14 (such as off of a truck bed 15) a couple of inches, and the vehicle 14 can be driven away with the interchangeable equipment sled 10 staying in place on the camper jacks 96. The jack receiving slot 98 can preferably be located at the top portion 28 of the frame 16 and a plurality of jack receiving slots 98 can be located along the top portion 28 on the first side 44 and second side 46. The interchangeable equipment sled 10 can also be lowered to ground level with camper jack 96 inserted into multiple receiving slots 98.

Another example of a lift mechanism is a hydraulic lift that can lift the interchangeable equipment sled 10 off of the vehicle 14. One example is a hydraulic camper leg which can be integrated into the interchangeable equipment sled 10 or added as needed. The hydraulic lift can also move the interchangeable equipment sled 10 onto a platform, a rack, onto a floor, or any other storage area. The lift mechanism allows the interchangeable equipment sled 10 to be removed or attached to a vehicle 14 within 10 minutes. The hydraulic lift can be operated manually or by the application with BLUETOOTH® or wireless communication. Once on the platform, the platform can be moved with pneumatic wheels for storage either manually or with the application.

The present invention provides for a method of adding the interchangeable equipment sled 10 to a vehicle 14, by operating a lift mechanism 94 to lift the interchangeable equipment sled 10 (such as from the ground level, a platform, or other storage area), placing the interchangeable equipment sled 10 on the vehicle 14, and optionally locking the interchangeable equipment sled 10 in place. Most preferably, operating a lift mechanism 94 includes lowering the interchangeable equipment sled 10 with jack stands 96 onto the vehicle 14. Locking the interchangeable equipment sled 10 can include securing the rod 108 at the first end 110 to the attachment point 112 on the frame 16 and securing the rod 108 at the second end 114 to the tie down point 104 on the vehicle 14 as described above. The interchangeable equipment sled 10 can include any of the equipment 12 as described above.

The present invention provides for a method of removing the interchangeable equipment sled 10 from a vehicle 14 by optionally disconnecting or unlocking the interchangeable equipment sled 10 from the vehicle 14, operating the lift mechanism 94 to lift the interchangeable equipment sled 10 from the vehicle 14, and moving the vehicle 14 away. Most preferably, operating a lift mechanism 94 includes raising the interchangeable equipment sled 10 with camper jacks 96 from the vehicle 14. This method can further include moving the interchangeable equipment sled 10 to a platform and/or other storage area.

The sled 12 can be electrically powered from a battery mounted to sled 12 and/or powered by connecting to a seven blade or similar trailer plug installed on vehicle 14. Charging equipment (solar or corded) can be installed on sled 12 as well.

The present invention provides generally for a method using the interchangeable equipment sled 10, by driving a vehicle 14 including the interchangeable equipment sled 10, and using the equipment 12.

The present invention also provides for a method of using the interchangeable equipment sled 10 to fight a fire, by driving a vehicle 14 including the interchangeable equipment sled 10 with fire equipment 12 to a fire scene, and using the fire equipment 12 to fight the fire. This method is useful in fighting fires in areas where large fire trucks cannot access.

The present invention provides for a method of using the interchangeable equipment sled 10 to charge a vehicle's 14 battery, by driving a vehicle 14 including the interchangeable equipment sled 10 with battery equipment 12, wherein the battery equipment 12 is operatively connected to the vehicle 14, and charging the vehicle 14 with the battery equipment 12. The method can further include the step of activating or stopping charging with the battery equipment 12 with an application on a smartphone.

The present invention provides for a method of using the interchangeable equipment sled 10 to add fuel to a vehicle's 14 fuel tank, by driving a vehicle 14 including the interchangeable equipment sled 10 with fueling equipment 12, wherein the fueling equipment 12 is operatively connected to a fuel tank of the vehicle 14, and adding fuel to the vehicle 14 with the fueling equipment 12. The method can further include the step of activating or stopping adding fuel with the fueling equipment 12 with an application on a smartphone.

The interchangeable equipment sled 10 can be used on its own. For example, an individual can buy an interchangeable equipment sled 10 to keep on their property if they live far from a fire station so that they can use the equipment 12 themselves if needed.

The interchangeable equipment sled 10 provides several advantages. For example, volunteer firefighters can add the interchangeable equipment sled 10 to their own vehicle 14 when needed instead of having to go to a fire station to get equipment. The interchangeable equipment sled 10 allows fire stations to buy several sleds 10 for one or two vehicles 14, instead of having to buy multiple specialty vehicles that sit around unused most of the time. The interchangeable equipment sled 10 can be used with smaller vehicles 14 allowing them to move and access places that large fire trucks cannot. The amount of firefighting equipment available can be increased because separate trucks are not required for each piece of equipment.

Throughout this application, various publications, including United States patents, are referenced by author and year and patents by number. Full citations for the publications are listed below. The disclosures of these publications and patents in their entireties are hereby incorporated by reference into this application in order to more fully describe the state of the art to which this invention pertains.

The invention has been described in an illustrative manner, and it is to be understood that the terminology which has been used is intended to be in the nature of words of description rather than of limitation.

Obviously, many modifications and variations of the present invention are possible in light of the above teachings. It is, therefore, to be understood that within the scope of the appended claims, the invention can be practiced otherwise than as specifically described.

What is claimed is:

1. An interchangeable equipment sled comprising a frame holding equipment operatively attached thereto, said interchangeable equipment sled being rapidly mountable or demountable on a vehicle.

2. The interchangeable equipment sled of claim 1, wherein said frame is made of steel.

3. The interchangeable equipment sled of claim 1, wherein said frame is chosen from the group consisting of solid and hollow.

4. The interchangeable equipment sled of claim 1, wherein said frame includes a base portion and a raised portion operatively attached to said base portion.

5. The interchangeable equipment sled of claim 4, wherein said frame is capable of receiving a fork of from a forklift through a slot between said base portion and said raised portion.

6. The interchangeable equipment sled of claim 4, wherein said raised portion includes a plurality of crossbars supporting said equipment.

7. The interchangeable equipment sled of claim 4, wherein said frame includes a top portion for receiving said equipment that is operatively attached through a plurality of vertical portions to said base portion.

8. The interchangeable equipment sled of claim 1, wherein said frame is sized to fill a vehicle bed.

9. The interchangeable equipment sled of claim 4, wherein said equipment is operatively attached to said raised portion.

10. The interchangeable equipment sled of claim 1, wherein said equipment is chosen from the group consisting of fire equipment, batteries, fuel tanks, pesticide tanks, dumpster equipment, welding equipment, salt equipment, sand equipment, and combinations thereof.

11. The interchangeable equipment sled of claim 1, wherein said equipment is fire equipment, and includes a hose, a hose reel, a pump, and a water tank.

12. The interchangeable equipment sled of claim 11, wherein said water tank includes a plurality of baffles to prevent movement of water in said water tank.

13. The interchangeable equipment sled of claim 1, wherein said equipment includes at least one equipment rack and at least one utility compartment.

14. The interchangeable equipment sled of claim 1, wherein said frame further includes a control panel having controls for said equipment.

15. The interchangeable equipment sled of claim 14, wherein said control panel includes at least one light switch, a remote spot light, a traffic director control, a hose reel switch, a hose reel valve, a discharge valve, a tank fill/recirculate valve, a tank to pump valve, a primer switch/valve, an inlet pressure gauge, a discharge pressure gauge, a pump throttle, a tank level gauge, and a pump electric start.

16. The interchangeable equipment sled of claim 14, wherein said control panel is accessible when a tailgate of said vehicle is up.

17. The interchangeable equipment sled of claim 1, further including a GPS tracking device.

18. The interchangeable equipment sled of claim 1, wherein said interchangeable equipment sled is removable from said vehicle without removing a tailgate from said vehicle.

19. The interchangeable equipment sled of claim 4, wherein said frame includes a plurality of wheels removably attached along said base portion.

20. The interchangeable equipment sled of claim 1, wherein said equipment is capable of being operated by a mechanism chosen from the group consisting of manually and by an application on a smartphone.

21. The interchangeable equipment sled of claim 1, wherein said vehicle is chosen from the group consisting of a car, pickup truck, flat bed truck, semi truck, and trailer.

22. The interchangeable equipment sled of claim 1, further including a locking mechanism for locking said interchangeable equipment sled in place on said vehicle.

23. The interchangeable equipment sled of claim 22, wherein said locking mechanism includes a tie down plate having a plurality of tie down points mounted to a gooseneck puck system of said vehicle, and at least one rod removably attached at a first end to an attachment point of said frame and removably attached at a second end to said tie down point.

24. The interchangeable equipment sled of claim 1, wherein rapidly mountable or demountable is further defined as said interchangeable equipment sled being able to be removed from or added to said vehicle in 10 minutes.

25. The interchangeable equipment sled of claim 1, wherein said frame includes at least one jack receiving slot for receiving a camper jack allowing said frame to be lifted from said vehicle with camper jacks.

26. The interchangeable equipment sled of claim 25, wherein said at least one jack receiving slot is located at a top portion of said frame.

27. A method of adding an interchangeable equipment sled to a vehicle, including the steps of:
operating a lift mechanism to lift the interchangeable equipment sled; and
placing the interchangeable equipment sled on the vehicle.

28. The method of claim 27, wherein said lift mechanism is further defined as at least one camper jack that is placed within a jack receiving slot operatively integrated in the frame of the interchangeable equipment sled.

29. The method of claim 28, wherein said operating step is further defined as lowering the interchangeable equipment sled with the camper jacks onto the vehicle.

30. The method of claim 27, wherein the lift mechanism is further defined as a hydraulic lift.

31. The method of claim 27, wherein the interchangeable equipment sled is further defined as a frame holding equipment that is rapidly interchangeable on a vehicle.

32. The method of claim 27, further including the step of locking the interchangeable equipment sled in place.

33. The method of claim 32, wherein said locking step is further defined as securing a rod at a first end to an attachment point on a frame of the interchangeable equipment sled and securing the rod at a second end to a tie down point on the vehicle.

34. The method of claim 27, wherein said method is performed within 10 minutes.

35. A method of removing an interchangeable equipment sled from a vehicle, including the steps of:
operating a lift mechanism to lift the interchangeable equipment sled from the vehicle; and
moving the vehicle away.

36. The method of claim 35, wherein the lift mechanism is further defined as at least one camper jack that is placed within a jack receiving slot operatively integrated in the frame of the interchangeable equipment sled.

37. The method of claim 36, wherein said operating step is further defined as raising the interchangeable equipment sled with the camper jacks from the vehicle.

38. The method of claim 35, wherein the lift mechanism is further defined as a hydraulic lift.

39. The method of claim 35, further including the step of moving the interchangeable equipment sled to a platform.

40. The method of claim 35, wherein the interchangeable equipment sled is further defined as a frame holding equipment that is rapidly interchangeable on a vehicle.

41. The method of claim 35, further including before said operating step, the step of unlocking the interchangeable equipment sled from the vehicle.

42. The method of claim 41, wherein said unlocking step is further defined as removing a rod at a first end from an attachment point on a frame of the interchangeable equipment sled and removing the rod at a second end to from tie down point on the vehicle.

43. The method of claim 35, wherein said method is performed within 10 minutes.

44. A method using an interchangeable equipment sled, including the steps of:
driving a vehicle including the interchangeable equipment sled to a location; and
using equipment on the interchangeable equipment sled.

45. The method of claim 44, wherein the interchangeable equipment sled is further defined as a frame holding equipment that is rapidly interchangeable on a vehicle.

46. The method of claim 44, wherein the vehicle is chosen from the group consisting of a car, pickup truck, flat bed truck, semi truck, and trailer.

47. The method of claim 44, wherein the equipment is chosen from the group consisting of fire equipment, batteries, fuel tanks, pesticide tanks, dumpster equipment, welding equipment, salt equipment, sand equipment, and combinations thereof.

48. A method of using the interchangeable equipment sled to fight a fire, including the steps of:
driving a vehicle including the interchangeable equipment sled with fire equipment to a fire site; and
using the fire equipment to fight the fire.

49. The method of claim 48, wherein the interchangeable equipment sled is further defined as a frame holding equipment that is rapidly interchangeable on a vehicle.

50. The method of claim 48, wherein the vehicle is chosen from the group consisting of a car, pickup truck, flat bed truck, semi truck, and trailer.

51. The method of claim 48, wherein said fire equipment includes a hose, a hose reel, a pump, and a water tank.

52. The method of claim 48, wherein the fire site is in a location not accessible by a fire truck.

53. A method of using an interchangeable equipment sled to charge a vehicle's battery, including the steps of:
driving a vehicle including the interchangeable equipment sled with battery equipment, wherein the battery equipment is operatively connected to the vehicle; and
charging the vehicle with the battery equipment.

54. The method of claim 53, wherein the interchangeable equipment sled is further defined as a frame holding equipment that is rapidly interchangeable on a vehicle.

55. The method of claim 53, further including the step of activating or stopping charging with the battery equipment with an application on a smartphone.

56. A method of using an interchangeable equipment sled to add fuel to a vehicle's fuel tank, including the steps of:
driving a vehicle including the interchangeable equipment sled with fuel equipment, wherein the fuel equipment is operatively connected to a fuel tank of the vehicle; and
adding fuel to the vehicle with the fuel equipment.

57. The method of claim 56, wherein the interchangeable equipment sled is further defined as a frame holding equipment that is rapidly interchangeable on a vehicle.

58. The method of claim 56, further include the step of activating or stopping adding fuel with the fuel equipment with an application on a smartphone.
